(19) United States
(12) Patent Application Publication
(10) Pub. No.: US 2008/0030032 A1
(43) Pub. Date: Feb. 7, 2008

(54) Vacuum device for removal of animal waste

(76) Inventor: Sandra R. Gill, Cordova, TN (US)

Correspondence Address: LITMAN LAW OFFICES, LTD., P.O. BOX 15035, CRYSTAL CITY STATION, ARLINGTON, VA, 22215, US

(21) Appl. No.: 11/882,320

(22) Filed: Jul. 31, 2007

Related U.S. Application Data
(60) Provisional application No. 60/834,742, filed on Aug. 2, 2006.

(51) Int. Cl. A01K 29/00

(52) U.S. Cl. 294/1.3

(57) ABSTRACT

The vacuum device for removal of animal waste is a vacuum suction device for the removal and disposal of excretory waste material. The vacuum includes a vacuum housing having opposed ends, with a recess being formed in an upper surface of the suction end. A suction motor is disposed in the housing, and a handle is pivotally attached to the handle end thereof. A disposable waste receptacle is releasably disposed within the recess and defines an intake chamber for receiving the excretory waste material. The intake chamber is in fluid communication with the vacuum housing, and a filter element is mounted within the intake chamber adjacent the attachment end of the receptacle. Upon actuation, the waste material enters the intake chamber, and the waste receptacle and waste material may be removed and disposed of.

### CROSS-REFERENCE TO RELATED APPLICATION

This application claims the benefit of U.S. Provisional Patent Application Ser. No. 60/834,742, filed Aug. 2, 2006.

### BACKGROUND OF THE INVENTION

1. Field of the Invention

The present invention relates to devices for picking up animal waste from lawns, sidewalks, etc., and particularly to a vacuum device for the removal of animal waste to automate the process.

2. Description of the Related Art

Pet owners are often required, to remove and dispose of the excretory waste generated by their pet animals by local laws, codes, or homeowners associations. Even when not required to do so by law or regulation, courteous pet owners feel motivated to clean up after their pets to keep their neighbors happy, to keep their own lawns clean, and to maintain the quality of their neighborhood and the environment generally. Such waste deposited on the ground not only presents offensive odors, but can cause harm to the environment, and can further be hazardous to other animals and to humans.

Pet owners typically collect the deposited fecal matter in a disposable bag, which is manually wrapped around the feces, or with a mechanical device, which is either used to carry the feces to a waste disposal site or for deposit into a disposable bag. Manually picking up the feces for insertion into the disposable bag brings the pet owner into direct contact with the fecal matter, which may cause infectious health problems for the pet owner. Further, the user may injure his or her back or knees through continuously stooping and squatting to position his or her hand near the ground.

Although the use of a mechanical device for carrying the feces prevents the pet owner from directly contacting the fecal material, such devices are typically not disposable, and must then be carried into the owner's home for cleaning. This not only creates more work for the user, but offers the same risk of an infectious health problem. It would be desirable to provide a tool for removing animal excretory waste that provides for transport and disposal of the animal waste without subjecting the user to direct contact with the potentially infectious waste. Thus, a vacuum device for removal of animal waste solving the aforementioned problems is desired.

### SUMMARY OF THE INVENTION

The vacuum device for removal of animal waste is a vacuum suction device for the removal and disposal of pet feces and the like. The vacuum device includes a vacuum housing having opposed ends, with a recess being formed in an upper surface of one of the ends. A suction motor is disposed in the vacuum housing, and a handle is pivotally attached to the vacuum housing. The handle may be selectively folded against the vacuum housing, allowing the user to use the vacuum in a handheld configuration. Further, a wheel is preferably pivotally mounted to a lower surface of the vacuum housing.

A disposable waste receptacle is releasably received within the recess, and defines an intake chamber for receiving the excretory waste material. The disposable waste receptacle is selectively and releasably locked within the recess. The receptacle is in fluid communication with the vacuum housing, and a filter element is mounted within the intake chamber adjacent the suction end of the vacuum housing. The disposable waste receptacle further has an open mouth at the intake end through which the waste material passes upon actuation of the suction motor.

The vacuum may further include a shoulder-mounted carrying strap and may also use at least one rechargeable battery for powering the suction motor. Upon selective actuation of the suction motor, the waste material enters the receptacle, and after use, the waste receptacle and waste material may be removed from the recess and transported to a waste disposal site for disposal thereof. A flap is preferably pivotally mounted within the receptacle adjacent the intake end of the receptacle for trapping the excretory waste material therein.

These and other features of the present invention will become readily apparent upon further review of the following specification and drawings.

### BRIEF DESCRIPTION OF THE DRAWINGS

FIG. 1 is an environmental, perspective view of a vacuum device for removal of animal waste according to the present invention.

FIG. 2 is a perspective view of the vacuum device for removal of animal waste according to the present invention.

FIG. 3 is a partially exploded perspective view of the vacuum device for removal of animal waste according to the present invention.

FIG. 4 is a partially exploded side view of a disposable waste receptacle of the vacuum device for removal of animal waste according to the present invention, with the receptacle broken away and partially in section.

Similar reference characters denote corresponding features consistently throughout the attached drawings.

### DETAILED DESCRIPTION OF THE PREFERRED EMBODIMENT

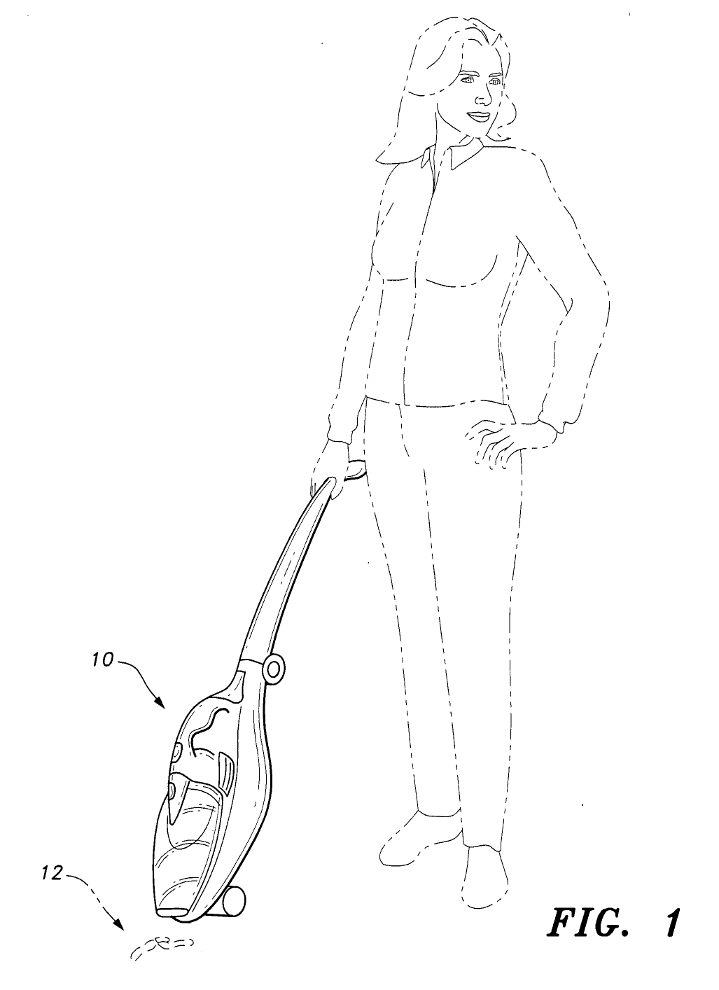

The present invention is directed towards a vacuum device for the removal of animal waste, the vacuum device being designated generally as 10 in the drawings. In FIG. 1, the vacuum device 10 is shown with the handle extended for use to pick up fecal material 12 from the ground for later transport and disposal at a suitable waste disposal site. Vacuum device 10 allows the user to transport and dispose of the waste in a sanitary and convenient manner.

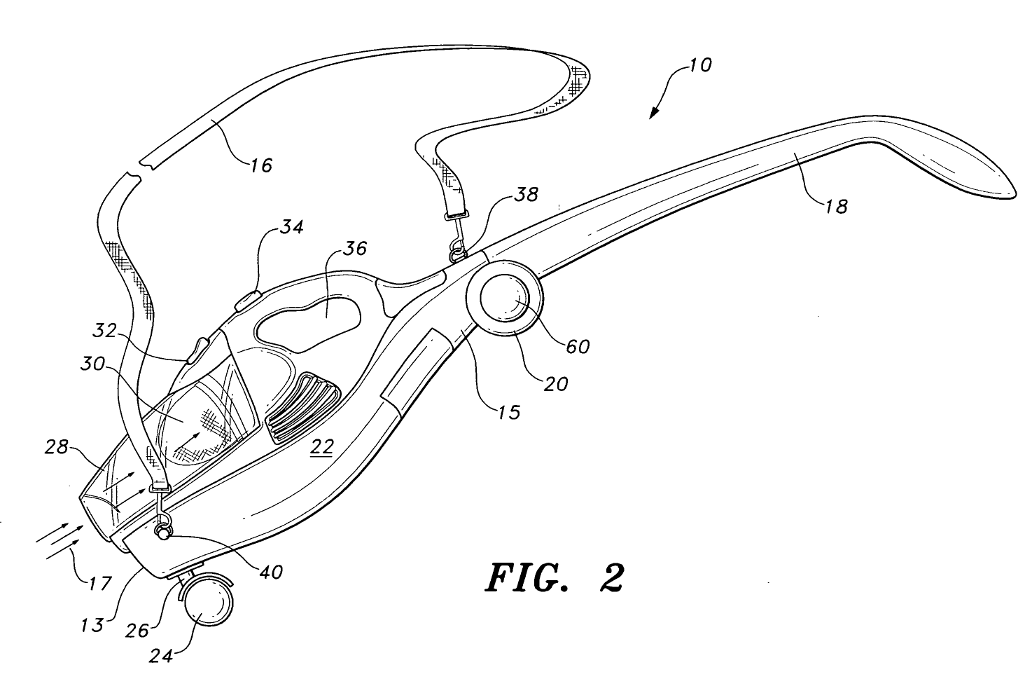

As best shown in FIG. 2, the vacuum device 10 includes a vacuum housing 22 having opposed ends 13 and 15, respectively. The vacuum housing 22 may be formed from plastic or any other suitable rugged and lightweight material. A handle 18 is pivotally mounted to one end of vacuum housing 22 by a hinge or pivot 20. The handle 18 is adapted for grasping by the user in an upright position, as shown in FIG. 1, when the handle is fully extended. Handle 18 is preferably formed from the same material as vacuum housing 22, but may also be formed from any suitable rugged and lightweight material so that the device 10 can be conveniently lifted and carried by the user.

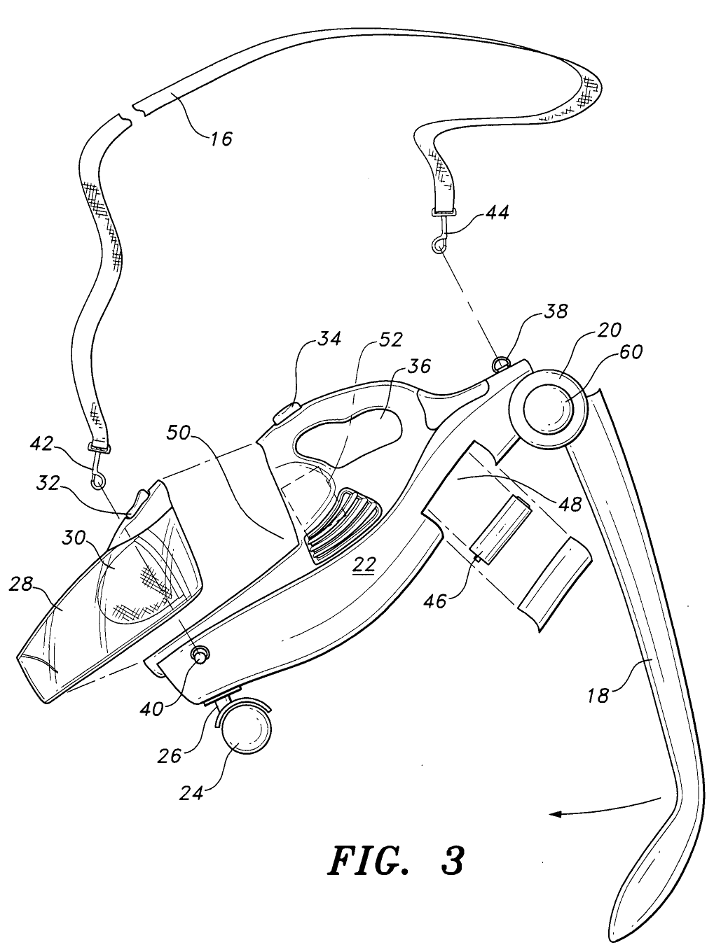

Pivot 20 allows the user to selectively and releasably lock the handle 18 in the extended position shown in FIG. 2. Through actuation of a release button 60, the handle 18 may be rotated (as illustrated by the directional arrow in FIG. 3) into a folded or collapsed state, allowing the user to operate the vacuum device in a second handheld configuration, or to fold the handle 18 for compact storage and transport.

An opening 36 is formed through the upper surface of vacuum housing 22 adjacent the handle end 15 thereof and is dimensioned and configured for receiving the fingers of the user. In the handheld configuration, the user may releasably grasp the vacuum housing 22 by inserting his or her fingers through the opening 36. The handle 18 may be rotated back into the extended position of FIG. 2 and locked in place by locking pivot 20 so that the user has the option of using the device in the extended position of FIG. 1 or the retracted or folded configuration of FIG. 3. It should be understood that locking pivot 20 may be any suitable locking hinge or pivotal joint.

A shoulder strap 16 may be provided so that the vacuum device 10 may be carried and supported on the user's shoulder or back. The shoulder strap 16 includes a pair of releasable fasteners 42, 44, e.g., snap hooks, secured to opposite free ends thereof for releasable attachment to rings 38, 40 mounted on the exterior surface of vacuum housing 22.

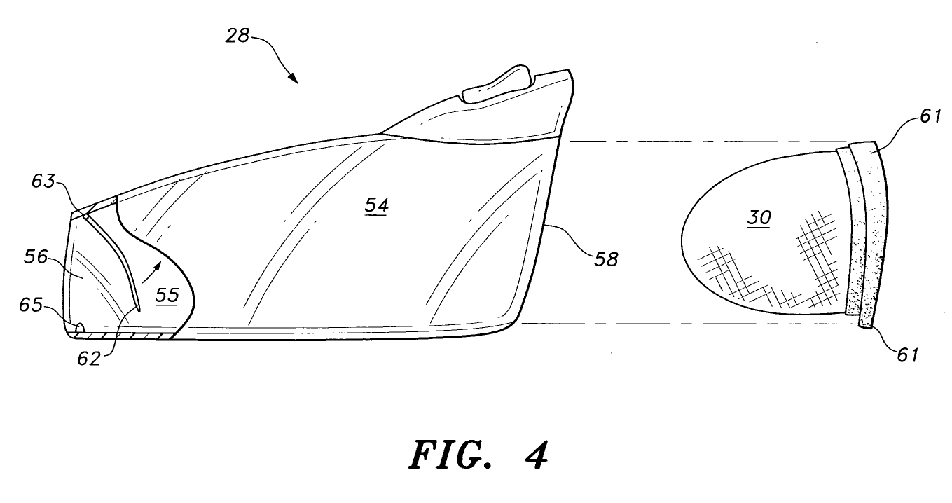

A recess 50 is formed in the upper surface of vacuum housing 22 adjacent the suction end 13 thereof. The recess 50 releasably receives a disposable waste receptacle 28. As best shown in FIG. 4, the disposable waste receptacle 28 includes an elongated housing 54, having opposed open ends 56, 58, respectively. Housing 54 is hollow, defining an intake chamber 55. The housing 54 is preferably formed from a lightweight and disposable plastic material, or any other suitable disposable and biodegradable material.

As shown in FIG. 3, a suction motor 52 is disposed within vacuum housing 22 and is in fluid communication with the intake chamber 55 of housing 54, which defines a chute when the disposable waste receptacle 28 is received within recess 50. In operation, the user positions the open intake or mouth 56 of housing 54 adjacent the fecal matter 12, as shown in FIG. 1, and actuates suction motor 52. Suction motor 52 is preferably powered by one or more rechargeable batteries 46 disposed within a battery compartment 48 formed within vacuum housing 22 for portable operation. However, it should be understood that suction motor 52 may be powered by any suitable power source. Suction motor 52 may be any suitable vacuum motor or other source of powered and controllable suction.

The user actuates suction motor 52 through engagement of button or control switch 34, which is in electrical communication with the suction motor 52 and battery 46. Once the suction motor 52 has been actuated, a negative air pressure is generated within the intake chamber 55 of housing 54, sucking both environmental air and the fecal matter 12 into the chamber 55 (illustrated by flow arrows 17 in FIG. 2).

The fecal matter (and other environmental waste) is prevented from passing into the suction motor 52 and vacuum housing 22 by a filter element 30, mounted within the attachment end 58 of housing 54. The filter element 30 may be formed of any suitable filtering material, and may include an annular rim or lip 61 for engaging the annular edge of housing 54 defining the attachment end 58. Annular rim or lip 61 may form a friction fit with housing 54, or may form a fluid-tight seal with housing 54. Although shown as having a substantially parabolic cross-sectional contour, it should be understood that filter element 30 may have any suitable contour. Filter element 30 is preferably formed from a biodegradable material so that the housing 54 and filter element 30 may be disposed of in an environmentally safe manner.

A flap 62, which may be formed from rubber or any other suitable material, is pivotally mounted via a pivot pin 63 or the like to housing 54 adjacent the mouth 56 of housing 54. The flap 62 is prevented from pivoting external to housing 54 by a stop member 65 or the like. When suction motor 52 is actuated, the negative pressure within open interior region 55 pivots the flap 62 in the direction indicated by the directional arrow in FIG. 4. Air and fecal matter 12 may freely enter the proximal end 56 and pass under flap 62. However, when the suction motor 52 is turned off, and the pressure within the housing 54 normalizes, the flap 62 pivots under the force of gravity (or by resilience, depending on the means for attaching flap 62 to housing 54) to cover the intake or mouth 56 and trap the fecal matter 12 within the intake chamber 55.

Once the fecal waste 12 has been trapped within housing 54, the disposable waste receptacle 28 may be removed from recess 50 for transport to a waste disposal site. The disposable waste receptacle 28 is releasably locked to the vacuum housing 22 within recess 50 by a latch, clasp or any other suitable means of locking engagement. In the preferred embodiment, the user may depress button 32, which unlatches the disposable waste receptacle 28 from the vacuum housing 22.

In order to position the vacuum device 10 adjacent the fecal waste material 12, a wheel 24 may be pivotally mounted to a wheel mount 26, formed on the lower surface of the vacuum housing 22. As illustrated in FIG. 1, the vacuum device 10 can be moved so that the intake 56 of the disposable waste receptacle 28 is positioned adjacent the fecal matter 12. When handle 18 is in the first extended position, the wheel 24 facilitates transport of the vacuum device 10 to and from the location of the fecal matter 12.

The containment of fecal matter 12 within housing 54 allows the user to transport and dispose of the fecal matter 12 without having to come into direct contact with the fecal matter 12. Further, by forming the disposable waste receptacle 28 from biodegradable and other environmentally safe materials, both the disposable waste receptacle 28 and the fecal matter 12 may be disposed in any suitable disposal site without risking contamination or damage to the environment.

It is to be understood that the present invention is not limited to the embodiment described above, but encompasses any and all embodiments within the scope of the following claims.

I claim:

1. A vacuum device for removal of animal waste, comprising:
a vacuum housing having a handle end and an opposed suction end, a recess being formed in the suction end of the vacuum housing;
a suction motor disposed in the vacuum housing and oriented to apply suction at the suction end of the vacuum housing;
a handle pivotally attached to the handle end of the vacuum housing;
a disposable waste receptacle releasably disposed in the recess of the vacuum housing, the receptacle having an attachment end releasably attached to the housing and an opposing intake end having an open mouth, the receptacle defining an intake chamber in fluid communication with the suction motor; and
a filter element mounted within the intake chamber adjacent the suction end of the vacuum housing for preventing animal waste from entering the housing, whereby the animal waste is suctioned into the intake chamber and the receptacle is detached from the housing in order to dispose of both the animal waste and the disposable waste receptacle.

2. The vacuum device for removal of animal waste as recited in claim 1, further comprising a flap pivotally mounted within the disposable waste receptacle adjacent the open mouth thereof to trap the animal waste within the intake chamber.

3. The vacuum device for removal of animal waste as recited in claim 1, further comprising a wheel mounted for rotation to a lower surface of said vacuum housing.

4. The vacuum device for removal of animal waste as recited in claim 1, further comprising means for selectively and releasably locking the handle in an extended position.

5. The vacuum device for removal of animal waste as recited in claim 4, wherein said means for selectively and releasably locking the handle includes a release button, whereby the user may actuate the release button to unlock the handle from the extended position.

6. The vacuum device for removal of animal waste as recited in claim 1, wherein said vacuum housing has an opening formed therethrough, the opening being positioned adjacent the handle end, the opening being dimensioned and configured for receiving the user's fingers, whereby the user may grasp the vacuum housing through insertion of the user's fingers within the opening, thus allowing the vacuum device to be utilized in a handheld configuration.

7. The vacuum device for removal of animal waste as recited in claim 1, further comprising a shoulder strap attached to said vacuum housing.

8. The vacuum device for removal of animal waste as recited in claim 7, further comprising means for releasably securing the shoulder strap to said vacuum housing.

9. The vacuum device for removal of animal waste as recited in claim 1, wherein said vacuum housing has a battery chamber formed therein, the vacuum device further comprising at least one battery removably received within the battery chamber, the at least one battery being in electrical communication with said suction motor for applying powering thereto.

10. The vacuum device for removal of animal waste as recited in claim 9, wherein the at least one battery is a rechargeable battery.

11. The vacuum device for removal of animal waste as recited in claim 1, wherein said filter element includes an annular rim formed thereon for releasable mounting to the attachment end of said disposable waste receptacle.

12. The vacuum device for removal of animal waste as recited in claim 11, wherein said filter element has a substantially parabolic cross-sectional shape, a closed end of said filter element extending within the intake chamber.

13. The vacuum device for removal of animal waste as recited in claim 1, further comprising means for selectively and releasably locking said disposable waste receptacle to said vacuum housing.

14. The vacuum device for removal of animal waste as recited in claim 13, wherein the means for selectively and releasably locking said disposable waste receptacle to said vacuum housing includes a receptacle release button, whereby the user may actuate the receptacle release button to unlock the disposable waste receptacle from the vacuum housing.
